(19) United States
(12) Patent Application Publication
(10) Pub. No.: US 2007/0180473 A1
(43) Pub. Date: Aug. 2, 2007

(54) METHOD AND APPARATUS FOR RECORDING BROADCAST PROGRAMS BY TRACKING CHANGE OF BROADCASTING TIME

(75) Inventors: Yu Kyoung Song, Yongin-si (KR); Kyung Ju Lee, Goyang-si (KR)

Correspondence Address: LEE, HONG, DEGERMAN, KANG & SCHMADEKA, 660 S. FIGUEROA STREET, Suite 2300, LOS ANGELES, CA, 90017, US

(73) Assignee: LG Electronics Inc.

(21) Appl. No.: 11/616,725

(22) Filed: Dec. 27, 2006

Related U.S. Application Data
(60) Provisional application No. 60/756,433, filed on Dec. 30, 2005.

(51) Int. Cl. G06F 13/00; H04N 7/18; G06F 3/00; H04N 5/445; H04N 7/173

(52) U.S. Cl. 725/58; 725/39; 725/40; 725/81; 725/78; 725/88

(57) ABSTRACT

A method for recording broadcasting programs by using EPG (Electronic Program Guide) information in accordance with the present invention creates a scheduled recording item by referring to a guide item of a program chosen as a recording object by the user, determines whether broadcasting time of the created scheduled recording item has been changed by checking the corresponding guide item, and when broadcasting time is found changed, updates the created scheduled recording item in order for changed broadcasting time to be included therein.

### CROSS-REFERENCE TO RELATED APPLICATIONS

Pursuant to 35 U.S.C. § 119(a), this application claims the benefit of U.S. Provisional Application Ser. No. 60/756,433 fled on Dec. 30, 2005, the contents of which is hereby incorporated by reference herein in its entirety.

### BACKGROUND OF THE INVENTION

1. Field of the Invention

The present invention is related to a method for recording received broadcasting programs by making use of recording devices on a network such as the one based on UPnP.

2. Description of the Related Art

People can make good use of various home appliances such as refrigerators, TVs, washing machines, PCs, and audio equipments once such appliances are connected to a home network. For the purpose of such home networking, UPnP™ (hereinafter, it is referred to as UPnP for short) specifications have been proposed.

The logical structure of a network based on UPnP comprises a plurality of UPnP devices, services, and control points. A service on a UPnP network represents a smallest control unit on the network. A service is modeled by state variables and one or more than one service can be installed in an appliance for managing states of the particular appliance or properly carrying out functions thereof.

A CP (Control Point) on a UPnP network represents a control application equipped with functions for detecting and controlling otter devices and/or services. A CP can be operated on an arbitrary device, the device being a physical device such as a PDA providing a user with a convenient interface. A CP can also be installed in AV equipments such as TVs and video recorders along with other services.

On a UPnP based network, PG (Electronic Program Guide) information about a radio or TV broadcasting program is received and processed to be suited for UPnP specification (such operations of information receiving and processing can be carried out in another equipment on the same network, e.g., set top box), thereby being stored in a central media server in the form of an item; therefore, program guide information is managed as an item by CDS (Content Directory Service) within the media server. That is to say, as shown in FIG. 1, program guide information is managed as EPG items 11 in a container 10 of a particular name (EPG) and one item corresponds to one broadcasting program.

As shown in FIG. 2, therefore, metadata of a single EPG item contains information about title of the corresponding broadcasting program, broadcasting channel, broadcasting time, genre, etc. In this way, created EPG items can be inquired by browsing and/or search action of a control point, thereby being displayed to the user or the information thereof can be utilized by a particular equipment (e.g., PVR (Personal Video Recorder)).

### SUMMARY OF THE INVENTION

The present invention is directed to provide a method and apparatus for enabling designated scheduled recording to be conducted normally based on guide information of a broadcasting program even when broadcasting time of the broadcasting program is changed.

One method for recording a broadcasting program by using program guide information in accordance with the present invention comprises creating a scheduled recording item with reference to a guide item of a program selected for recording, determining whether broadcasting time of the created scheduled recording item has been changed by checking the associated guide item, and when broadcasting time is found changed, updating the created scheduled recording item in order for changed broadcasting time to be included therein.

In one embodiment according to the present invention, identifying information of an associated guide item is included in the scheduled recording item and information about program title and broadcasting time contained in the guide item is duplicated and included as well,

In one embodiment according to the present invention, identifying information about a recording device and created scheduled recording item is further added to a guide item associated with the scheduled recording item.

In one embodiment according to the present invention, when the created scheduled recording item is deleted at the request of a user, identifying information about a recording device and scheduled recording item is also deleted, the identifying information having been previously added to the guide item.

In one embodiment according to the present invention, for the purpose of updating the created scheduled recording item, the created scheduled recording item is deleted and a scheduled recording item is newly created, the newly scheduled recording item having information identical to the deleted item except for information about the changed broadcasting time.

In one embodiment according to the present invention, operations of creating a scheduled recording item and by checking change of broadcasting time of the scheduled recording item updating the scheduled recording item according to the checking result are conducted at the request of the same control application.

In another embodiment according to the present invention, operations of creating a scheduled recording item and by checking change of broadcasting time of the scheduled recording item, updating the scheduled recording item according to the checking result are conducted at the request of separate control applications.

In the above embodiment according to the present invention, one control application from the separate control applications is installed in a device recording broadcasting programs, the control application checking change of broadcasting time of a scheduled recording item and requesting an operation of updating the scheduled recording item in accordance with the checking result.

In the above embodiment according to the present invention, when a scheduled recording item is created, the control application requesting an operation of updating the scheduled recording item is notified of the occurrence of creation and/or provided with information about the created item.

### BRIEF DESCRIPTION OF THE DRAWINGS

The accompanying drawings, which are included to provide a further understanding of the invention, illustrate the preferred embodiments of the invention, and together with the description, serve to explain the principles of the present invention.

In the drawings:

FIG. 1 illustrates a storage structure of contents and EPG (Electronic Program Guide) information built in a home server on a UPnP based network;

FIG. 2 illustrates configuration information of an EPG item composed for a broadcasting program;

FIG. 3 illustrates networked devices carrying out a method for processing scheduled recording based on EPG items in accordance with one embodiment of the present invention;

FIG. 4A illustrates a procedure of signal processing between associated devices and/or services for processing scheduled recording based on EPG items in accordance with one embodiment of the present invention, the procedure being carried out on the network of FIG. 3;

FIG. 4B illustrates a procedure of signal processing between associated devices and/or services for processing scheduled recording based on EPG items in accordance with another embodiment of the present invention, the procedure being carried out on the network of FIG. 3;

FIGS. 5A and 53 respectively illustrate a scheduled recording item created by designating scheduled recording upon selection of an EPG item and an EPG item with augmented information;

FIG. 5C illustrates an example where information of a scheduled recording item has been updated in accordance with the present invention;

FIG. 6 illustrates networked devices carrying out a method for processing scheduled recording based on EPG items in accordance with another embodiment of the present invention; and

FIG. 7 illustrates a procedure for signal processing between associated devices and/or services for processing scheduled recording based on EPG items in accordance with yet another embodiment of the present invention, the procedure being carried out on the network of FIG. 6.

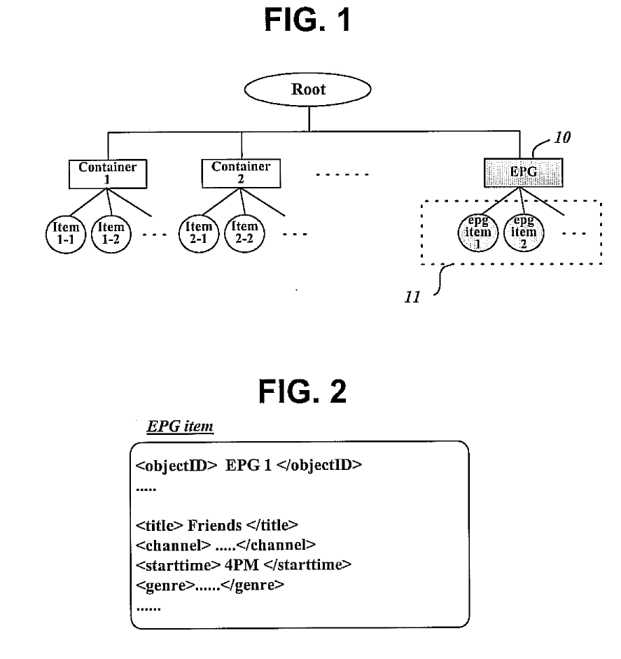

### DETAILED DESCRIPTION OF THE PREFERRED EMBODIMENTS

Hereinafter, according to the present invention, preferred embodiments of a method and apparatus for securing a video signal recording space will be described in detail with reference to appended drawings.

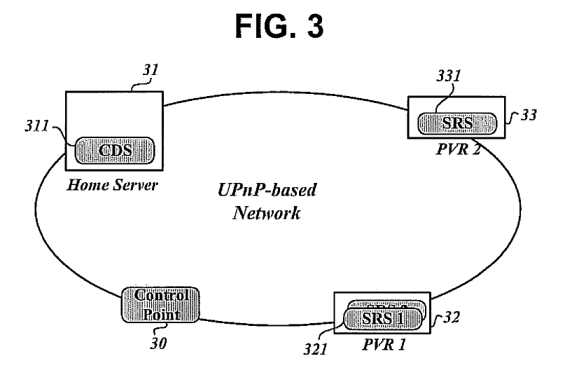

FIG. 3 is a simplified illustration about networked devices carrying out one embodiment of a method for processing scheduled recording based on EPG items in accordance with the present invention. The network shown in FIG. 3, intended for the convenience of describing the present invention, is not limited to networked devices where the present invention is applied and comprises CP (control point) 30, home server 31, and two PVRs (Personal Video Recorders) 32, 33 as a network based on UPnP. The CP 30, although not shown in the figure, can be carried out in a physical device such as TV or remote controller. The home server 31 stores various media files inside home, EPG items, etc and possesses CDS 311 for managing such items. Each of the PVRs 32, 33 has a service to control recording of scheduled recording programs (SRS: Scheduled Recording Service). One PVR can include more than one scheduled recording service as in the PVR 1 32.

In the description of the present invention, networked devices and/or service names based on UPnP specification are used. Content described in the following, however, can be directly applied to other network standards by adaptively substituting necessary elements or utilizing other relevant terms with regard to differences of the standards where the present invention may apply. In this regard, therefore, the present invention is not limited to a network based on UPnP.

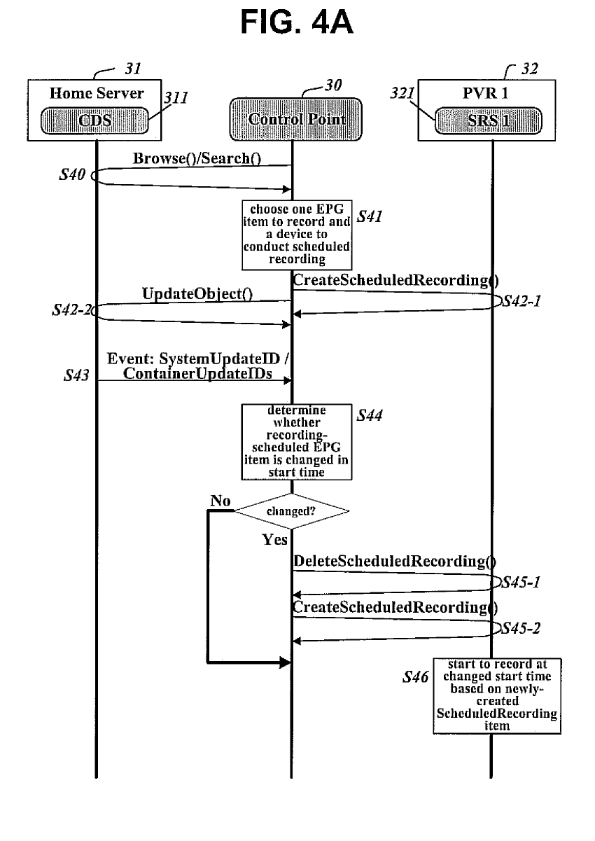

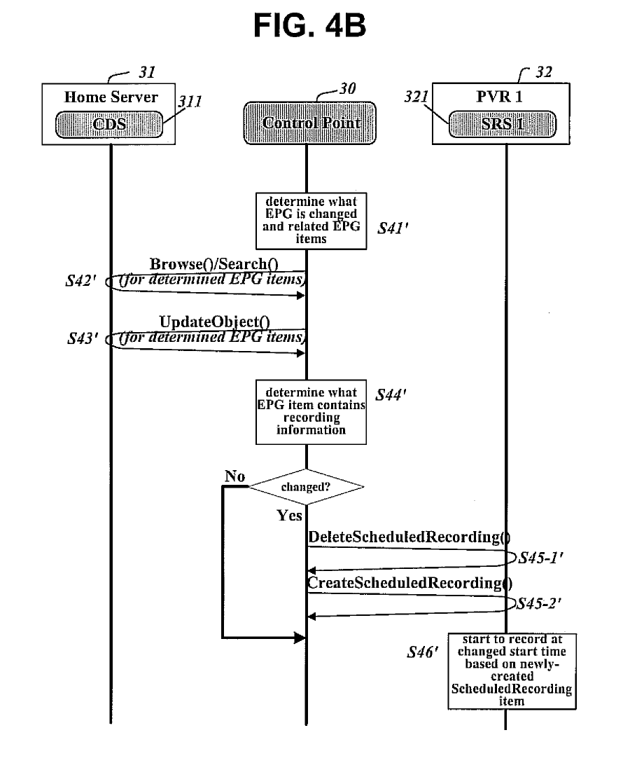

FIG. 4A illustrates a procedure of signal processing between associated devices and/or services for processing scheduled recording based on EPG items in accordance with one embodiment of the present invention, the procedure being carried out on the network of FIG. 3.

First, a user, by using the CP 30, invokes browsing or search action for an EPG item on the CDS 311 in order to confirm a program of scheduled recording (S40). A particular condition or option part of title, broadcasting time period (date and time), channel, etc.) can be added to the invocation in order to adjust the range of EPG items to be browsed or searched for. The user, by using a relevant UI (User Interface) provided by the CP 30, chooses one EPG item to record from among EPG items queried by the action and PVR to conduct recording (S41). In the description of the present embodiment, an EPG item with metadata as shown in FIG. 2 is assumed to have been chosen as a recording item and PVR 1 32 as a recording device.

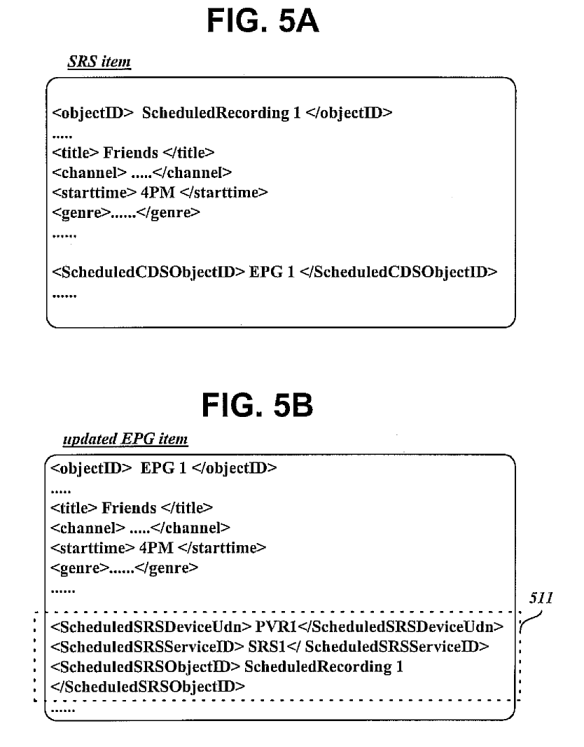

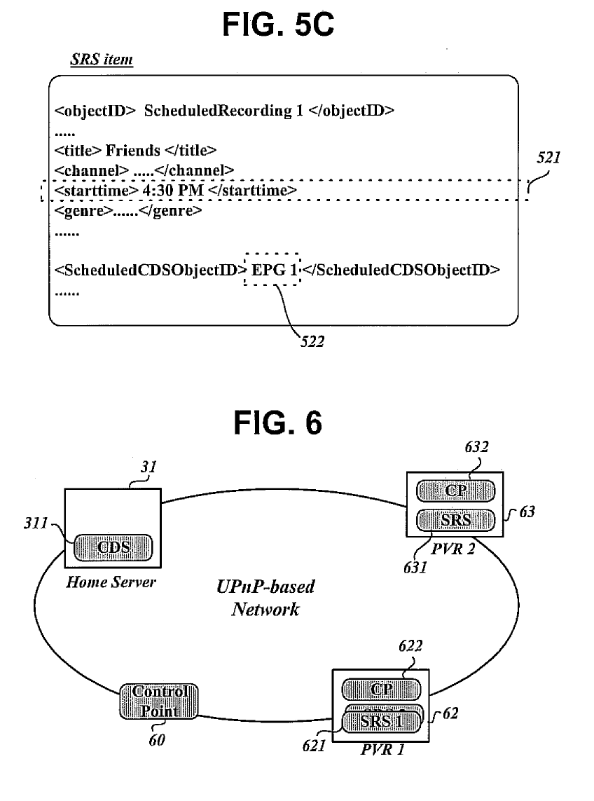

Subsequently, the CP 30 creates a scheduled recording item (hereinafter, it is alternatively referred to as SRS (Scheduled Recording Service) item) having information as shown in FIG. 5A and creates recording information (UDN (Unique Device Name) of a recording device, Service ID of SRS to be used within the recording device, object identifier of the created scheduled recording item, etc.) for a chosen EPG item. For the created scheduled recording item, object creation action is invoked on a first SRS 321 of the PVR 1 32 which has been chosen as a recording device (S42-1); for the created recording information, as shown in FIG. 5B, object update command is invoked in order for the recording information 511 to be added to the corresponding EPG item (S42-2).

After the above operation, the CP 30 is notified of change of an EPG container within the home server 31 through an event (S43-1). In order to be notified of change within an EPG container by an event, the CP 30 must carry out an event subscription to CDS 311 of the home server 31. Information contained in EPG items within the home server 31, as mentioned above, is updated by a service within the same device such as set top box through continuous reception thereof, by which an EPG item in accordance with the latest program guide information can be contained and accordingly, the CDS 311 invokes an event. In case an event subscription has been made as above, the CDS 311 delivers an event containing list of changed container IDs' to the CP 30 each tune a change occurs in a container which is under the control of the CDS 311 (S43-1).

The CP 30, from among EPG items belonging to an EPG container obtained from an event, determines whether broadcasting start time element <starttime> of the same EPG item obtained from previous browsing or searching action has been changed, recording information of EPG items being contained in metadata as shown in FIG. 5B (S44).

In another embodiment according to the present invention, instead of detecting change of an EPG item through an event (S43), the CP 30 directly recognizes change of program guide information and updates the corresponding EPG item on the CDS 311 according thereto. FIG. 4B illustrates a procedure of signal processing between devices and/or services according to the present embodiment; as shown in the figure, the CP 30 receives program guide information directly or from another device such as set top box, confirms program guide information whose broadcasting time has been changed by comparing the received program guide information with previously received program guide information, and determines EPG items corresponding to program guide information containing changed broadcasting time (S41′). Once EPG items to change are determined in such a way, EPG items before change are obtained by invoicing browsing or searching action for the items on the CDS 311 (S42′); when EPG items before change are obtained, the CP 30 invokes update action for the corresponding EPG items in order to reflect changed program guide information (S43′).

Subsequently, the CP 30 determines, from among EPG items before change obtained previously, which EPG item contains recording information in its metadata (S44′).

In the embodiment of FIG. 4A, if broadcasting start time element information of one EPG item has been changed, e.g., if broadcasting start time of an EPG item of FIG. 5B has been changed from 4 PM to 4:30 PM or if, as in the embodiment of FIG. 4B, recording information is contained in one EPG item before change and update information about the EPG item is such that broadcasting start time has been changed to 4:30 PM during the determining step (S44′), the CP 30 makes reference to recording information contained in the EPG item information, determines PVR 1 32 as a recording device, and carries out update operation on a first scheduled recording service 321 in order for the corresponding SRS item to include changed broadcasting start time information as shown in FIG. 5C. In the embodiments according to the present invention, update of an SRS item comprises deletion of a previous SRS item (S45-1, S45-1′) and creation of a new SRS item having changed broadcasting start time information (S45-2, S45-2′).

In the embodiment of FIG. 4B, it may be the case that the CP 30 is not the control point which has created an SRS item on the recording device PVR 1 32. In the embodiment according to the present invention, CP 30 of FIG. 4B is a control point implemented within a device such as set top box which directly receives and decodes broadcasting program signals. Therefore, instead of configuring information about an SRS item to create (S45-2′) after deletion (S45-1′) by making reference to recording information within an EPG item before change and change information of program guide information corresponding to the EPG item, information of an SRS item to be created (S45-2′) in a first scheduled recording service 321 can be configured by malting reference to recording information within an EPG item, inquiring of the first scheduled recording service 321 within the PVR 1 32 about an associated SRS item and storing the associated SRS item, and changing only broadcasting time of a program among the stored SRS item information after deleting the inquired SRS item (S45-1′).

While the CP 30 carries out such an operation, a first SRS 321 within the PVR 1 32 periodically examines SRS items registered to itself and when it becomes broadcasting start time designated by any of the items, by malting reference to information of metadata contained in the corresponding item, receives and records a broadcasting program scheduled for recording (S46, S46′). According to the above method, after a scheduled recording item has been created in accordance with scheduled recording setting, recording is conducted at changed time by tracking a program schedule even when broadcasting time of an EPG item associated with the scheduled recording item is changed.

FIG. 6 illustrates networked devices carrying out another embodiment of a method for processing scheduled recording based on EPG items in accordance with the present invention. The exemplified network of FIG. 6 is different from that according to the embodiment of FIG. 3 in that control points 622, 632 are installed on respective PVRs 62, 63 in addition to SRSs 621, 631 for controlling recording programs designated for scheduled recording.

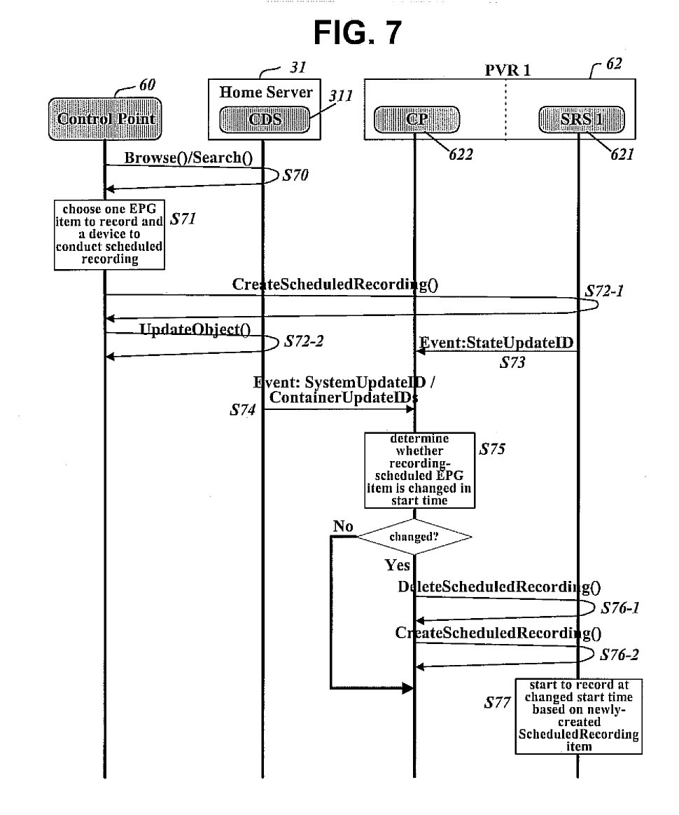

FIG. 7 illustrates a procedure of signal processing between associated devices and/or services for processing scheduled recording based on EPG items in accordance with another embodiment of the present invention, the procedure being carried out on the network of FIG. 6.

First, a user, by using the CP 60, invokes browsing or search action for EPG items on the CDS 311 it order to determine scheduled recording programs (S70). For the above invocation, range of EPG items to be browsed or searched for can be adjusted by adding a particular condition or option (part of title, broadcasting time period (date and time), channel, etc.). The user, by using a relevant UI provided by the CP 60, chooses one EPG item to record from among EPG items inquired by the action and PVR to carry out recording (S71). In the description of the present embodiment, an EPG item having metadata as shown in FIG. 2 is assumed to have been chosen as a recording item and PVR 1 62 as a recording device.

According to the above, the CP 60 creates a scheduled recording item having information as shown in FIG. 5A and recording information for a chosen EPG item (UDN of a recording device, Service ID of SRS to be used within the recording device, object identifier of the created scheduled recording item, etc). For the created scheduled recording item, object creation action is invoked on the first SRS 621 of the PVR 1 62 chosen as a recording device (S72-1) and for the created recording information, object update command is invoked in order for the recording information 511 to be added to the corresponding EPG item (S72-2). The invocation order of the two actions (S72-1, S72-2) can be safely exchanged.

Meanwhile, the first SRS 621, when one SRS item is created, generates an event and delivers information of the created SRS item to a control point 622 within the same device (S73). For this purpose, the CP 622 registers permission of the corresponding event with the first SRS 621 at the time of device initialization. In another embodiment according to the present invention, instead of generating an event of the first SRS 621, the CP 622 can periodically inquires into the existence of an SRS item registered for the first SRS 621 and state information thereof.

Being notified of registration of an SRS item and information of the item having been obtained as well, the CP 622 is notified of EPG items whose contents have been changed from the home server 31 by an event as described in the previous embodiment (S74). The CP 622 then, among notified EPG items, examines a particular EPG item only corresponding to the identifier 522 of an EPG item registered with the previously obtained SRS item and determines whether broadcasting start element information <starttime> of a notified EPG item is different from broadcasting start time information within a registered SRS item (S75). Since an EPG item, as mentioned above, is continuously updated by a service within a device such as set top box, the latest program guide information can be obtained from an event.

If broadcasting start time element information of one EPG item associated with an SRS item has been found changed during the determining step (S75), for example, if broadcasting start time of an EPG item of FIG. 5B has been changed from 4 PM to 4:30 PM, the CP 622 makes reference to recording information contained in the EPG item information, specifies a recording device PVR 1 62, and for a first SRS 621 within the device, carries out a update operation in order for the corresponding scheduled recording item to include changed broadcasting start time information 521 as shown in FIG. 5C. In the present embodiment, update of an SRS item comprises deletion of a previous SRS item (S76-1) and creation of a new SRS item having changed broadcast start time information (S76-2).

While the CP 622 carries out the above operation, a first SRS 621 within the PVR 1 62 periodically examines SRS items registered therewith and when it becomes broadcasting start time designated by one item, makes reference to information of metadata contained in the corresponding item, thereby receiving and recording broadcasting program designated for scheduled recording. According to the above method, after a scheduled recording item having been created in accordance with scheduled recording setting, recording is conducted at changed time by tracking broadcasting time of a program even when broadcasting time of an EPG item associated with the scheduled recording item is changed.

In the description of the embodiment, signal and information exchange between CP 622 and an SRS 621 within the same device can be accomplished by a signal exchange protocol defined arbitrarily within the device without complying with signal and/or information format based on UPnP.

On the other hand, in the embodiments described above, if the user cancels recording of a program scheduled for recording by using a relevant UT provided by the CP 30, 60, namely, when deletion of a scheduled recording item registered with PVR is requested, the CP 30, 60 males reference to identifier (522 in the example of FIG. 5C) of an EPG item registered with an SRS item which is requested for deletion, inquires into the corresponding EPG item, and carries out an operation of deleting recording information (511 in the example of FIG. 5B) associated with a deleted SRS item, the information being contained in the EPG item.

The foregoing description of a preferred embodiment of the present invention has been presented for purposes of illustration. Thus, those skilled in the art may utilize the invention and various embodiments with improvements, modifications, substitutions, or additions within the spirit and scope of the invention as defined by the following appended claims.

What is claimed is:

1. A method for recording broadcasting programs by using program guide information, comprising:
creating a scheduled recording item with reference to guide item of a program selected for recording;
checking the guide item to determine whether broadcasting time of the created scheduled recording item is changed; and
updating the created scheduled recording item such that changed broadcasting time is included in the created scheduled recording item, if the broadcasting time is determined changed.

2. The method of claim 1, wherein the created scheduled recording item includes at least identifying information of the guide item.

3. The method of claim 2, wherein information about program title and broadcasting time contained in the guide item is copied into the created scheduled recording item.

4. The method of claim 1, wherein the creating step further adds identifying information about a recorder, a scheduled recording service to be used, and the created scheduled recording item to the guide item.

5. The method of claim 4, further comprising,
when the created scheduled recording item is deleted, deleting the identifying information about a recorder, scheduled recording service to be used, and scheduled recording item, wherein the identifying information has been added to the guide item.

6. The method of claim 1, further comprising,
starting recording of the selected program at time specified by the scheduled recording item.

7. The method of claim 1, wherein in the checking step, a guide item with changed broadcasting time information is notified through an event.

8. The method of claim 1, wherein the updating step deletes the created scheduled recording item and creates a new scheduled recording item having information identical to the deleted item except for information about the changed broadcasting time.

9. A networked apparatus for recording broadcasting programs by using program guide information, comprising:
a service, equipped in a recorder, for making the recorder record a broadcasting program specified by a set scheduled recording item at broadcasting time indicated by the item;
a server having guide items for programs stored therein; and
a control application browsing the guide items and creating a scheduled recording item in the service by referring to a guide item selected as a recording object among browsed guide items,
wherein the control application determines based on a guide item associated with the scheduled recording item whether broadcasting time of the scheduled recording item created in the service is changed, and updates the scheduled recording item created in the service if the broadcasting time is determined changed.

10. The apparatus of claim 9, wherein in order to determine whether the broadcasting time of the scheduled recording item created in the service is changed, the control application examines a guide item notified from the server through an event.

11. The apparatus of claim 9, wherein the control application further carries out an operation of adding identifying information about a recorder, a scheduled recording service to be used, and the created scheduled recording item to the associated guide item.

12. The apparatus of claim 11, wherein after deleting the created scheduled recording item at request of a user, the control application deletes identifying information about a recorder, a scheduled recording service to be used, and a scheduled recording item, the identifying information having been added to the associated guide item.

13. A networked apparatus for recording broadcasting programs by using program guide information, comprising:
a service, equipped in a recorder, for malting the recorder record a broadcasting program specified by a set scheduled recording item at broadcasting time indicated by the item;
a server having guide items for programs stored therein;
a first control application browsing the guide items and creating a scheduled recording item in the service by referring to a guide item selected as a recording object among browsed guide items; and
a second control application determining whether broadcasting time of the guide items is changed and, if a guide item with changed broadcasting time is associated with a scheduled recording item, updating the scheduled recording item to include the changed broadcasting time.

14. The apparatus of claim 13, wherein the second control application is equipped in a device for receiving and decoding broadcasting program signals.

15. The apparatus of claim 13, wherein the second control application, before updating the associated scheduled recording item, browses the associated scheduled recording item from the service and uses the browsed information at the updating.

16. A networked apparatus for recording broadcasting programs by using program guide information, comprising:
a service, equipped in a recorder, for making the recorder record a broadcasting program specified by a set scheduled recording item at broadcasting time indicated by the item;
a server having guide items for programs stored therein;
a first control application browsing the guide items and creating a scheduled recording item in the service by referring to a guide item selected as a recording object among browsed guide items; and
a second control application, equipped in the recorder, determining based on a guide item associated with the scheduled recording item whether broadcasting time of the scheduled recording item created in the service is changed, and updating the scheduled recording item created in the service.

17. The apparatus of claim 16, wherein in order to determine whether the broadcasting time of the scheduled recording item created in the service is changed, the second control application examines a guide item notified from the server through an event.

18. The apparatus of claim 16, wherein when a scheduled recording item is created, the service notifies the second control application of the occurrence of item creation and/or information of the created scheduled recording item.

19. The apparatus of claim 16, wherein the first control application further carries out an operation of adding identifying information about a recorder, a scheduled recording service to be used, and the created scheduled recording item to the associated guide item.

20. The apparatus of claim 19, wherein after deleting the created scheduled recording item at request of a user, the first control application deletes identifying information about a recorder, a scheduled recording service to be used, and a scheduled recording item, the identifying information having been added to the associated guide item.
